(19) United States
(12) Patent Application Publication
(10) Pub. No.: US 2007/0030100 A1
(43) Pub. Date: Feb. 8, 2007

(54) LTCC based electronically tunable multilayer microstrip-stripline combline filter

(76) Inventors: Mohammed Mahbubur Rahman, Glastonbury, CT (US); Qinghua Kang, Newark, DE (US); Khosro Shamsaifar, Ellicott city, MD (US)

Correspondence Address: James S. Finn, Box #8, 14431 Goliad Dr., Malakoff, TX, 75148, US

(21) Appl. No.: 11/546,808

(22) Filed: Oct. 11, 2006

Related U.S. Application Data
(63) Continuation of application No. 10/757,314, filed on Jan. 14, 2004.
(60) Provisional application No. 60/445,351, filed on Feb. 5, 2003.

(51) Int. Cl. H01P 1/203

(52) U.S. Cl. 333/205

(57) ABSTRACT

An embodiment of the present invention provides an apparatus, comprising a multilayer filter including a first resonator on a first layer of dielectric material or low-temperature-co fired-ceramic, a second resonator coupled to the first resonator on a second layer of dielectric material or low-temperature-co fired-ceramic, a third resonator coupled to the second resonator and cross coupled to the first resonator, and wherein a voltage tunable dielectric capacitor is connected to at least one of the resonators to electrically tune the multilayer filter.

### BACKGROUND OF THE INVENTION

The present invention generally relates to tunable filters, tunable dielectric capacitors, and, more particularly, this invention relates to a voltage-controlled LTCC based tunable filter.

Electronically tunable microwave filters have found wide applications in microwave systems. Compared to mechanically and magnetically tunable filters, electronically tunable filters have the most important advantage of fast tuning capability over a wide band application. Because of this advantage, they can be used in applications such as cellular, PCS (personal communication system), Point to Point, Point to multipoint, LMDS (local multipoint distribution service), frequency hopping, satellite communication, and radar systems. Electronically tunable filters can be divided into two types: one is a dielectric capacitor based tunable filter and the other is semiconductor varactor based tunable filter. Compared to the semiconductor varactor based tunable filters, tunable dielectric capacitor based tunable filters have the merits of lower loss, higher power-handling, and higher IP3, specifically at higher frequencies.

Tunable filters have been developed for radio frequency (RF) applications. They are tuned electronically by using either dielectric varactors or Micro-electro-mechanical systems (MEMS) based varactors. Tunable filters offer service providers flexibility and scalability, which were never possible before. A single tunable filter solution enables radio manufacturers to replace several fixed filters covering adjacent frequencies. This versatility provides front-end RF tunability in real time applications and decreases deployment and maintenance costs through software controls and reduced component count. Also, fixed filters need to be wide band so that the total number of filters to cover a desired frequency range does not exceed reasonable numbers. Tunable filters, however, are narrow band and maybe tuned in the field by remote command. Additionally, narrowband filters at the front end are superior from the systems point of view, because they provide better selectivity and help reduce interference from nearby transmitters. Two of such filters can be combined in diplexer or duplexer configurations.

Inherent in every tunable filter is the ability to rapidly tune the response using high-impedance control lines. The assignee of the present invention has developed and patented tunable filter technology such as the tunable filter set forth in U.S. Pat. No. 6,525,630 entitled, “Microstrip tunable filters tuned by dielectric varactors”, issued Feb. 25, 2003 by Zhu et al. This patent is incorporated in by reference. Also, patent application Ser. No. 09/457,943, entitled, “ELECTRICALLY TUNABLE FILTERS WITH DIELECTRIC VARACTORS” filed Dec. 9, 1999, by Louise C. Sengupta et al. This application is incorporated in by reference.

The assignee of the present invention and in the patent and patent application incorporated by reference has developed the materials technology that enables these tuning properties, as well as, high Q values resulting low losses and extremely high IP3 characteristics, even at high frequencies. The elaboration of the novel tunable material technology is elaborated on in the patent and patent application incorporated in by reference.

Also, tunable filters based on MEMS technology can be used for these applications. They use different bias voltages to vary the electrostatic force between two parallel plates of the varactor and hence change its capacitance value. They show lower Q than dielectric varactors, but can be used successfully for low frequency applications.

Thus, there is a strong need in the communications industry to provide several layers of dielectric material or low-temperature-co fired-ceramic (LTCC) tape based electronically tunable multilayer microstrip-stripline combline filter operable over a wide frequency band and that is small in size.

### SUMMARY OF THE INVENTION

An embodiment of the present invention provides an apparatus, comprising a multilayer filter including a first resonator on a first layer of dielectric material or low-temperature-co fired-ceramic, a second resonator coupled to the first resonator on a second layer of dielectric material or low-temperature-co fired-ceramic, a third resonator coupled to the second resonator and cross coupled to the first resonator, and wherein a voltage tunable dielectric capacitor is connected to at least one of the resonators to electrically tune the multilayer filter.

### BRIEF DESCRIPTION OF THE DRAWINGS

FIG. 1 illustrates a layout of the multilayer filter of the present invention;

FIG. 2 depicts a top layer (layer 9 in a preferred embodiment) of the combline filter of the present invention;

FIG. 3 depicts Layer 6 of a preferred embodiment (top ground pane for stripline) of the combline filter of the present invention;

FIG. 4 illustrates Layer 4 of a preferred embodiment of the combline filter of the present invention;

FIG. 5 illustrates Layer 3 of a preferred embodiment of the combline filter of the present invention;

FIG. 6 illustrates Layer 2 of a preferred embodiment (bottom ground pane for stripline) of the combline filter of the present invention;

FIG. 7 illustrates Layer 1 (including resistor layer) of a preferred embodiment of the combline filter of the present invention;

FIG. 8 illustrates the Bottom Layer of the combline filter of the present invention;

FIG. 9 graphically depicts the response of the filter tuned at three different frequencies.

### DESCRIPTION OF THE PREFERRED EMBODIMENT

It is an object of the present invention to provide a voltage-tuned filter having a very small size, low insertion loss, fast tuning speed, high power-handling capability, high IP3 and low cost in the RF and microwave frequency range. Compared to voltage-controlled semiconductor varactors, voltage-controlled tunable dielectric capacitors have higher Q factors, higher power-handling capability and higher third order intercept point (IP3). Voltage-controlled tunable diode varactors or voltage controlled MEMS varactors can also be employed in the filter structure to achieve the goal of this object, although with decreased performance. Yet another object of the present invention is to have a compact filter capable of being tuned over the three transmit bands of a wireless handset application.

A first embodiment of the present invention provides for a tunable filter in a low-temperature-co fired-ceramic (LTCC) package. The tuning elements are preferably voltage-controlled tunable dielectric capacitors or, in a less preferred alternate embodiment, MEMS varactors placed on the resonator lines of each filter. Since the tunable dielectric capacitors show high Q, high IP3 (low inter-modulation distortion) and low cost, the tunable filter in the present invention has the advantage of low insertion loss, fast tuning speed, and high power handling. It is also low-cost and provides fast tuning. The present technology makes tunable filters very promising in the contemporary communication system applications.

The tunable dielectric capacitor in the present invention is made from a low loss tunable dielectric film. The range of Q-factor of the tunable dielectric capacitor is between 50, for very high tuning material, and 300, for low tuning materials. It decreases with the increase of the frequency, but even at higher frequencies, say 30 GHz, can have values as high as 100. A wide range of capacitance of the tunable dielectric capacitors is available; for example, 0.1 pF to several pF. The tunable dielectric capacitor is a packaged two-port component, in which the tunable dielectric can be voltage-controlled. The tunable film is deposited on a substrate, such as MgO, LaAIO3, sapphire, Aha3 and other dielectric substrates. An applied voltage produces an electric field across the tunable dielectric, which produces an overall change in the capacitance of the tunable dielectric capacitor.

The tunable capacitors based on MEMS technology can also be used in the tunable filter and are part of this invention. At least two varactor topologies can be used, parallel plate and interdigital. In the parallel plate structure, one of the plates is suspended at a distance from the other plate by suspension springs. This distance can vary in response to electrostatic force between two parallel plates induced by applied bias voltage. In the interdigital configuration, the effective area of the capacitor is varied by moving the fingers comprising the capacitor in and out and changing its capacitance value. MEMS varactors have lower Q than their dielectric counterpart, especially at higher frequencies, but can be used in low frequency applications.

The tunable filter with asymmetric response consists of combline resonators implemented in microstrip-stripline form. In a preferred embodiment it can be a 3-pole tunable combline filter as described below. Variations of the capacitance of the tunable capacitor affect the distribution of the electric field in the filter, which in turn varies the resonant frequency.

The combline resonators are implemented in stripline as well as microstrip line form. The filter needs several layers of dielectric material or low-temperature-co fired-ceramic (LTCC) tape. In one preferred embodiment, a three-pole filter is realized using LTCC tapes, although it is understood that design choice would dictate the number of poles and number of layers provided and it is understood that any number of poles or layers are included in the scope of the present invention. The present preferred embodiment of the present invention and the one described below is a filter that uses a total of nine tape layers.

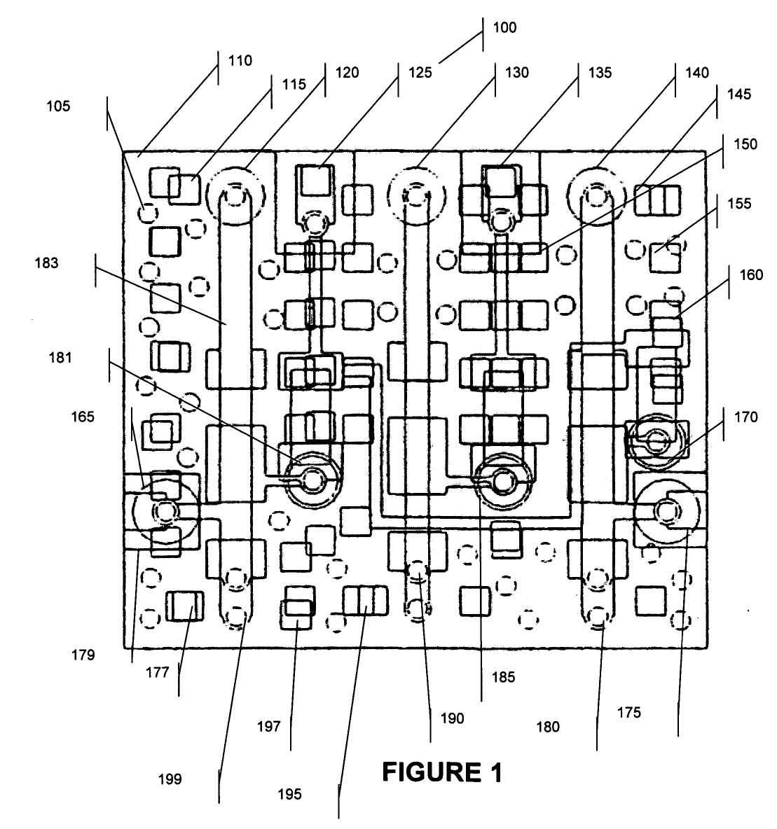

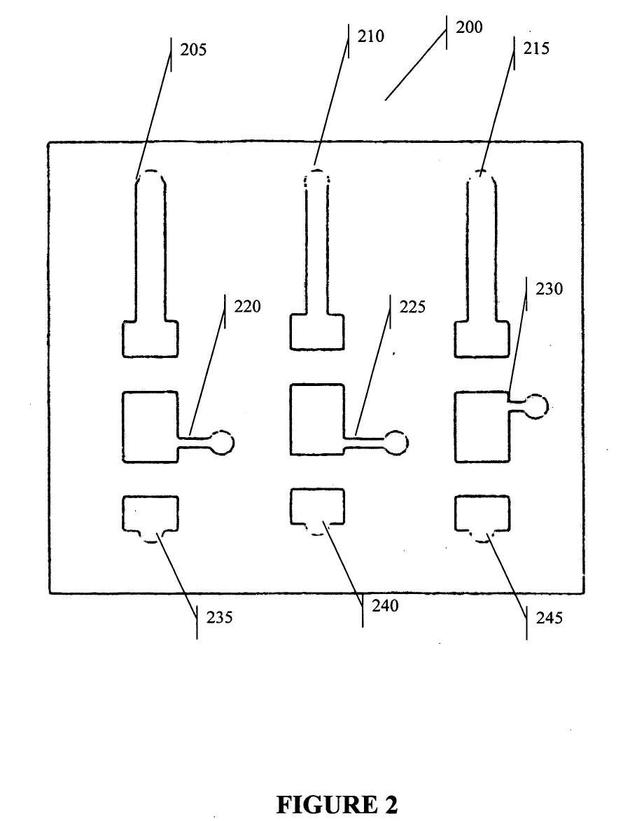

Turning now to FIG. 1, the layout of the filter is shown with all layers. All the layers have been shown separately in FIGS. 2 through 8 to assist in the understanding of the present invention. Shown generally in FIG. 1 at 100 is the multilayer microstrip-stripline combline filter module. Vias 105 are located on ground planes 110 (the present invention may have several layers of ground planes, but for purposes of the perspective of FIG. 1 will generally be referred to as 110) to connect the internal ground planes 110 which further include opening grids 115, 145, 155, 160, 177, 195 and 197. A thruhole 120 is positioned on ground plane 110 for the left-side microstrip-stripline resonator. A DC bias port is provided in the bottom layer and another thruhole 140 is provided for the right-side microstrip-stripline resonator. An isolation in the bottom layer of ground plane 110 for DC bias port is provided at 150. A thruhole for RF/IO port is depicted at 165 and a thruhole for right-side DC bais via is shown at 170 and the RF portion of the bottom layer at 175.

At 179 is an isolation in the bottom layer 110 for RF/IP port 165 and at 180 is a via connecting an inner stripline to the bottom ground plane 110. At 181 are thruholes for the left-side DC bias via and at 183 is an inner stripline portion of the microstrip-stripline resonator. Thruholes for center DC bias via is provided at 185. At 190 is a via connecting upper microstrip to upper internal ground plane 110 and at 199 is a via connecting inner stripline to bottom ground plane 110.

Turning now to FIG. 2 is shown a top layer (layer 9) of the combline filter of the present invention. Here, a microstrip portion of the multilayer microstrip-stripline combline filter module is shown at 200 with part of left-side microstrip line shown as 205, part of center microstrip line shown at 210 and part of right-side of microstrip line shown at 215. A connection for left-side resonator DC bias is shown at 220, a connection for center resonator DC bias at 225 and a connection for right-side resonator DC bias at 230. At 235 is part of the left-side microstrip line for mounting a varactor; at 240 is part of center microstrip line for mounting a varactor; and at 245 is part of right-side microstrip line for mounting a varactor.

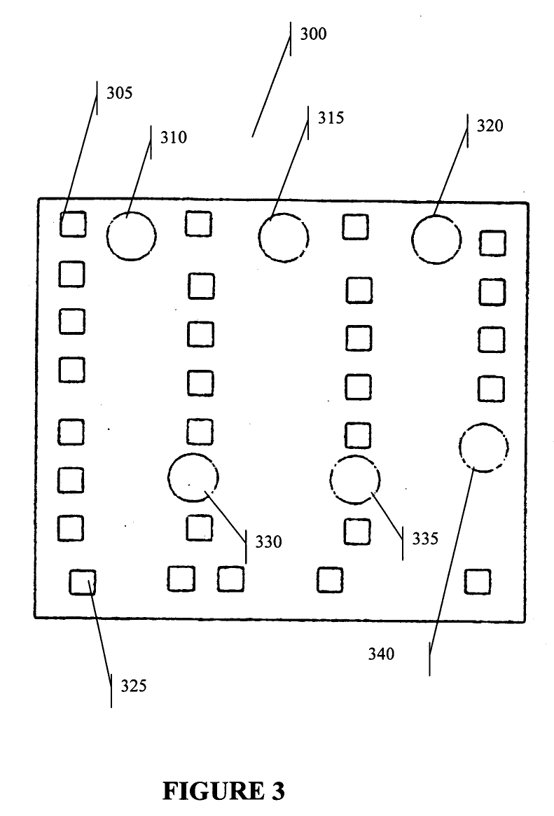

Referring now to FIG. 3 is depicted Layer 6 (top ground plane for stripline) of the combline filter of the present invention. Here upper internal ground plane of the multilayer microstrip-stripline combline filter module is depicted at 300 and opening grids in the ground plane are shown at 305 and 325. Thruholes are shown at 310, 315, 320, 330, 335 and 340.

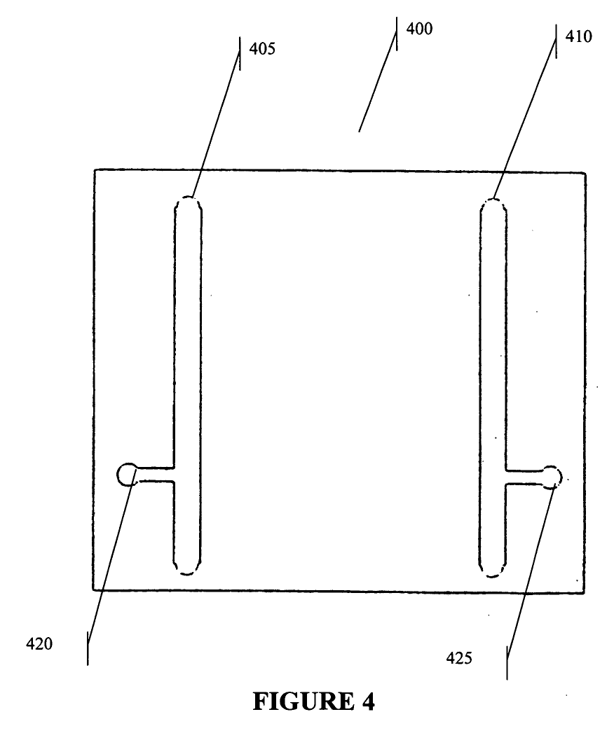

Referring now to FIG. 4 is illustrated Layer 4 of the combline filter of the present invention. Herein, stripline portion of left- and right-side resonators and the lower internal ground plane are depicted at 400. Stripline portion of left-side microstrip stripline resonator is at 405 and stripline portion of right-side microstrip-stripline resonator is shown at 410. Tapped RF I/O port at left-side microstrip-stripline resonator is depicted at 420 and Tapped RF I/O port at right-side microstrip-stripline resonator is depicted at 425.

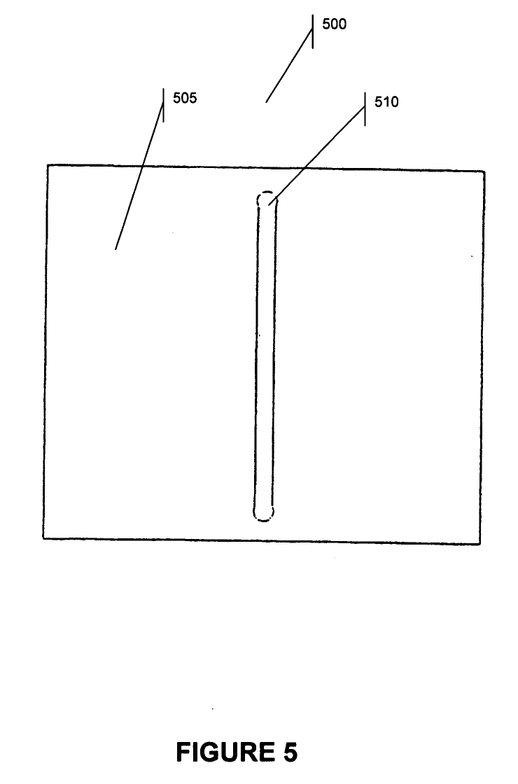

FIG. 5 illustrates Layer 3 of the combline filter of the present invention, wherein Asymmetrical stripline portion of center resonator and the lower internal ground plane is shown at 500 and lower internal ground plane for the striplines is illustrated at 505. Asymmetrical stripline portion of the center microstrip-stripline resonator is shown at 510.

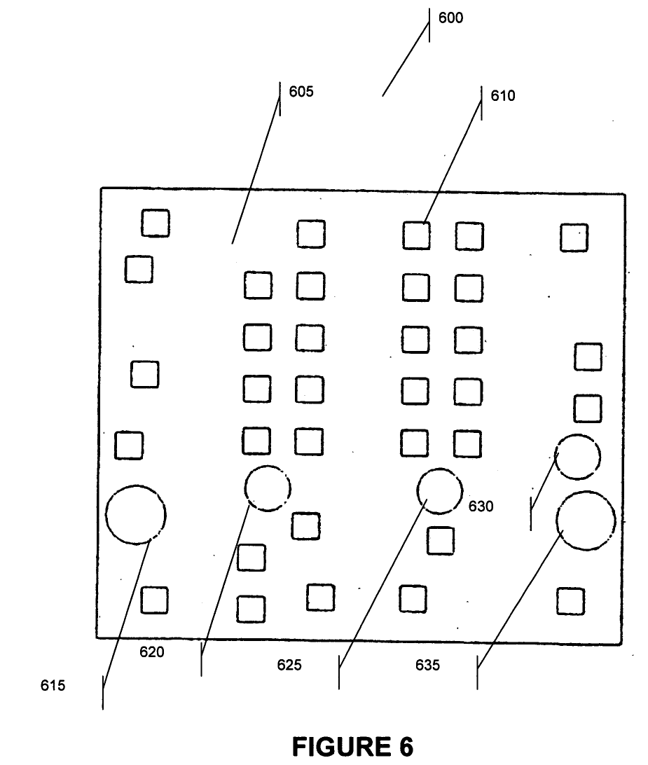

FIG. 6 illustrates Layer 2 (bottom ground pane for stripline) of the combline filter of the present invention, wherein lower internal ground plane of the multilayer microstrip-stripline combline filter module is generally shown as 600 and lower internal ground plane made from metallization is illustrated as 605. Further, opening grid in the lower internal ground plane is at 610 and thruhole for RF I/O port via 615, thruholes for DC bias vias at 620, 625 and 630. Finally, thruhole for RF I/O port via is shown at 635.

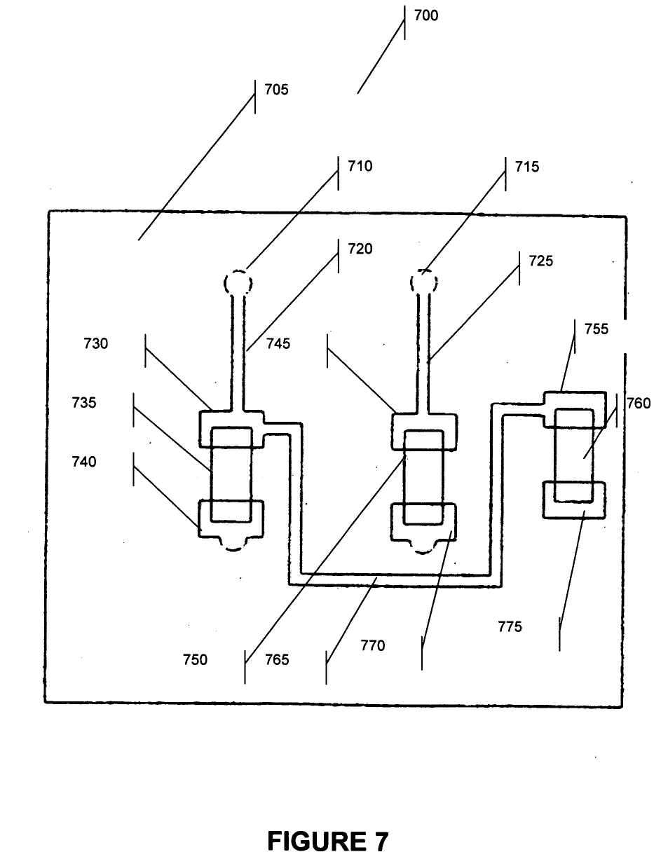

FIG. 7 illustrates Layer 1 (including resistor layer) of the combline filter of the present invention. The following table illustrates the components of FIG. 7 and are connected as shown graphically.

| | |
|---|---|
| 700 | RF choke resistors and the bottom metallization layer |
| 705 | Bottom metallized ground plane |
| 710 | Metal catch pad for connection to the DC bias port |
| 715 | Metal catch pad for connection to the DC bias port |
| 720 | Metal strip for the DC bias connection |
| 725 | Metal strip for the DC bias connection |
| 730 | Metal termination pad for the resistor |
| 735 | RF choke resistor |
| 740 | Metal termination pad for the resistor |
| 745 | Metal termination pad for the resistor |
| 750 | RF choke resistor |
| 755 | Metal termination pad for the resistor |
| 760 | RF choke resistor |
| 765 | Metal strip for the DC bias connection |
| 770 | Metal termination pad for the resistor |
| 775 | Metal termination pad for the resistor |

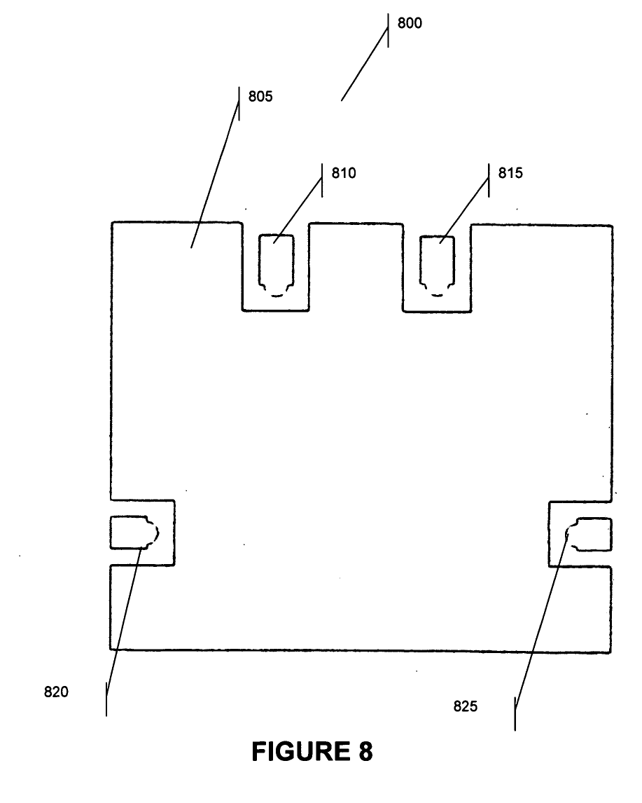

FIG. 8 illustrates the Bottom Layer of the combline filter of the present invention with RF, DC ports and the bottom metallization layer depicted generally as 800 and bottom metallized ground plane shown as 805. Further, DC bias ports 810 and 815 are illustrated as well as RF I/O ports 820 and 825

The regular combline resonator is roughly one eighth of a wavelength. If the combline resonator is implemented in one layer, the filter size is generally large. Therefore, the comb line resonators in the present invention are implemented in multilayer topology to miniaturize the filter. To achieve better Q from the resonator structure, the good portion of the resonator has been implemented in the stripline form. The stripline portions of the resonators are shown in FIGS. 4 and 5 as described above. The stripline portions of the two end resonators are in the same layer (layer 4). As shown in FIG. 5 at 500 the center resonator 510 is in a different layer 505. The resonators are placed in different layers to achieve less coupling between the adjacent resonators and to achieve the desired cross coupling between the two end resonators. The cross coupling between the two end resonators helps to create a transmission zero on the high side of the passband of the filter. This improves the high side selectivity at the expense of the low side selectivity degradation. This is desired for the transmit filters in the handset application.

The striplines go though apertures in the top ground plane (layer 6) to the top layer of the board. The microstrip portions of the resonators are folded back as shown in FIG. 1. Therefore, the size of the filter is reduced by almost half. Microstrip portions of the resonators are used to mount the tuning components (dielectric varactors/MEM varactors/varactor diode) and the DC blocking capacitors. The combline resonators are shorted to both ends. Therefore, the DC blocking capacitors are necessary to apply voltage to the varactors for tuning. The DC biasing circuit is implemented by a short length of high impedance line and a high resistor. It is possible to use a conventional quarter wave length high impedance line with quarter wave length radial stub for the biasing circuit; however, it occupies a larger amount of space, which makes the tunable filter larger. The varactors of the present invention have the good characteristic of drawing current in the few uA range. Therefore, the resistor in the biasing line doesn't drop any appreciable voltage. The assignee of the present invention has developed the varactors that can be used in the present invention. One such example is provided in co-owned in U.S. Pat. No. 6,531,936, entitled, “Voltage tunable varactors and tunable devices including such varactors” filed Mar. 11, 2003, by Chiu et al. This patent is incorporated in by reference.

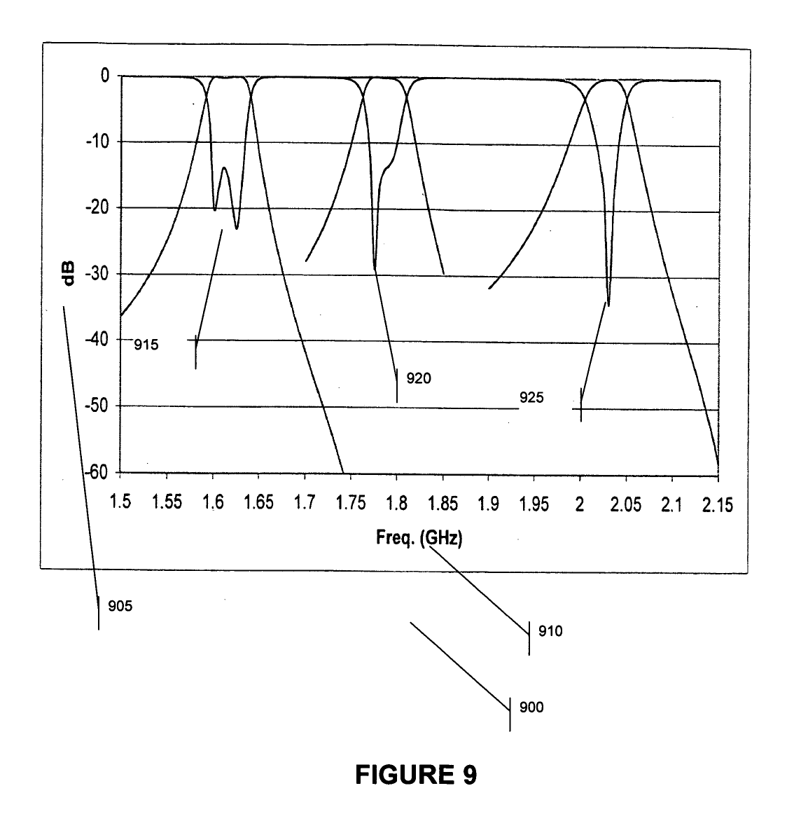

Turning now to FIG. 9, the graph illustrates the desirable performance abilities and frequency filter flexibility provided by the present invention by graphically depicting the response of the filter tuned at three different frequencies. Shown on the graph at 900 is the typical filter performance for the tunable multilayer microstrip-stripline combline filter. 905 illustrates the filter response of S-parameters in dB at 905 and tunable filter frequency range in GHz at 910. The graph further shows the filter response when varactors are at low or zero bias voltage at 915 and filter response when varactors are at an intermediate bias voltage 920 and filter response when varactors are at high bias voltage 925.

While the present invention has been described in terms of what are at present believed to be its preferred embodiments, those skilled in the art will recognize that various modifications to the disclose embodiments can be made without departing from the scope of the invention as defined by the following claims.

What is claimed is:

1. An apparatus, comprising:
a multilayer filter including a first resonator on a first layer of dielectric material or low-temperature-co fired-ceramic;
a second resonator coupled to said first resonator on a second layer of dielectric material or low-temperature-co fired-ceramic;
a third resonator coupled to said second resonator and cross coupled to said first resonator; and
wherein a voltage tunable dielectric capacitor is connected to at least one of said resonators to electrically tune said multilayer filter.

2. The apparatus of claim 1, further comprising a dc blocking capacitor in at least one of said resonators.

3. The apparatus of claim 2, further comprising DC biasing circuit associated with said filter.

4. The apparatus of claim 3, wherein said DC biasing lines include at least one resister to prevent leakage into said DC biasing lines.

5. The apparatus of claim 1, wherein there are a total of nine layers of LTCC tape or dielectric material.

6. The apparatus of claim 5, wherein at least two of said nine layerers are used as the inner ground plane to implement the stripline structure.

7. The apparatus of claim 6, wherein layer 2 and layer 6 are used as the inner ground plane to implement the stripline structure.

8. The apparatus of claim 7, wherein the portion of each combline resonator between said layer 2 and layer 6 is in stripline form and the remainder of the resonators are on the top layer and in microstripline form.

9. The apparatus of claim 4, wherein said at least one resister in the biasing circuit is implemented in layer 1 with resistive paste.

10. The apparatus of claim 7, further comprising an input transmission line connected to said first resonator and an output transmission line connected with said third resonator and wherein the input output lines are taken to the bottom plane through the apertures in layer 2.

11. The apparatus of claim 1, wherein the center frequency of the filter is tuned by changing the variable capacitor capacitance by changing the voltage.

12. A method, comprising:
using voltage to tune a multilayer filter by connecting a voltage tunable dielectric capacitor to at least one resonator in a multilayer filter that includes a first resonator on a first layer of dielectric material or low-temperature-co fired-ceramic;
a second resonator coupled to said first resonator on a second layer of dielectric material or low-temperature-co fired-ceramic; and
a third resonator coupled to said second resonator and cross coupled to said first resonator.

13. The method of claim 12, further comprising including a dc blocking capacitor in at least one of said resonators.

14. The method of claim 13, further comprising biasing said filter with a DC biasing circuit.

15. The method of claim 14, wherein said DC biasing lines include at least one resister to prevent leakage into said DC biasing lines.

16. An apparatus, comprising:
a multilayer filter including a first resonator on a first layer of dielectric material or low-temperature-co fired-ceramic;
a second resonator coupled to said first resonator on a second layer of dielectric material or low-temperature-co fired-ceramic;
a third resonator coupled to said second resonator and cross coupled to said first resonator; and
wherein a MEMS based varactor is connected to at least one of said resonators to tune said multilayer filter.

17. The apparatus of claim 16, wherein said MEMS varactor uses a parallel plate topology.

18. The apparatus of claim 16, wherein said MEMS varactor uses an interdigital topology.
